(19) United States
(12) Patent Application Publication
(10) Pub. No.: US 2013/0080384 A1
(43) Pub. Date: Mar. 28, 2013

(54) SYSTEMS AND METHODS FOR EXTRACTING AND PROCESSING INTELLIGENT STRUCTURED DATA FROM MEDIA FILES

(71) Applicant: Howard BRIGGS, Dronfield (GB)

(72) Inventor: Howard BRIGGS, Dronfield (GB)

(21) Appl. No.: 13/624,189

(22) Filed: Sep. 21, 2012

Related U.S. Application Data
(60) Provisional application No. 61/538,706, filed on Sep. 23, 2011.

(51) Int. Cl. G06F 17/30

(52) U.S. Cl. 707/610; 707/E17.005

(57) ABSTRACT

The automatic processing and indexing of video and audio source files including the automatic generation of and maintenance of video, audio, concordance, text and closed caption files corresponding to the media content of the source files. Generating and maintaining the files in such a way that the content of these files remains aligned so that the timing synchronization of the audio, the video, the text and closed caption information during play back is strictly maintained, even after text is edited and/or translated to another language.

This application claims the benefit of priority of U.S. Provisional Application No. 61/538,706, filed Sep. 23, 2011, which is incorporated by reference in its entirety herein.

### FIELD OF THE INVENTION

The present invention relates to processing of audio and video data. More particularly, the present invention relates to the automated processing of text data that has been generated by the process of speech recognition of audio data.

### BACKGROUND OF THE INVENTION

The use of digital audio and video has exploded over the past decade. In addition to the audio and video, corresponding text files reflecting the audio have become an equally important tool. In certain professions and applications, the inclusion of corresponding text and, in some instance, closed captions, while playing back the video and/or audio is critical. Examples include law enforcement, the medical profession, the legal profession and the educational field, particularly with students that have certain disabilities (e.g., hearing impaired students). As such, there is a huge demand for systems and/or methods that not only provide audio, video and accompanying text for such purposes, but systems and/or methods that do so in a way that the audio, video and text files are highly searchable, easily accessible, and incredibly accurate.

There are many known products on the market that have the ability to generate text files from a given an audio file. An example of such a system is Nuance's ASR (Dragon) engine. There are also products on the market that provide the ability to display and edit generated text files when playing back the corresponding video or audio content. However, these systems have many drawbacks. One significant drawback is their inability to provide, among other things, text and other related files whose contents are aligned relative to each other to insure synchronization of audio, video, text and, if employed, closed captions during play back. This is a particularly significant issue when the text is later edited or otherwise modified, as editing the text may further affect the alignment and synchronization. If the synchronization is significantly affected, the audio may end up being clipped during play black and, in addition, the presentation of text, audio, video and closed captioning may be offset in time relative to each other making it difficult for the user. Other drawbacks include the generation of text files that are unable to support robust and accurate searching capability when trying to identify specific, stored audio and video files, and the inability to provide text and close captioning in alternative languages instantaneously while, at the same time, maintaining the aforementioned alignment and synchronization.

Accordingly, there is a substantial need for a system and/or method that obviates these and other drawbacks and deficiencies associated with these known systems.

### SUMMARY OF THE INVENTION

The present invention relates to the automatic processing and indexing of video and audio source files. In general, the present invention obviates the aforementioned drawbacks and deficiencies by providing systems and/or methods that automatically generate and maintain video, audio, concordance, text and closed caption files corresponding to the media content of the source files. Moreover, the systems and/or methods of the present invention do in such a way that the content of these files remains aligned so that the timing synchronization of the audio, the video, the text and closed caption information during play back is strictly maintained.

The present invention also provides for a robust search capability due, at least in part, to the manner in which the audio and video source files are indexed and the manner in which the present invention refines the speech recognition processed data. The search capability allows the user to rapidly and accurately search for and identify specific audio and video files, that have been indexed and stored, using a keyword(s) or phrase(s), and then play back the identified file, or any segment thereof that contains the keyword(s) or phrase(s).

Additionally, the present invention allows the user, during play back, to edit the text associated with the identified file. In doing so, the present invention automatically updates one or more of the aforementioned files, including the text, refined concordance and closed caption files so that the content of the files remain aligned and synchronization during play back is strictly maintained as previously described

Still further, the present invention provides the ability to instantaneously convert the text and closed caption data from one language to another, for example, from English to French or English to Chinese. The present invention is able to do this without affecting the alignment or synchronization of the files.

The use of the present invention has particular relevance to the law enforcement as well as medical and legal practices, although there is clearly no limitation thereto. It also has relevance to individuals with varying degrees of disability, e.g., under Section 508 of the Rehabilitation Act, so that they may enjoy and benefit from the analyzed content through closed captioning in English and other languages.

As one of skill will appreciate from the description herein below, one advantage and/or objective of the present invention is that it eliminates the time and cost associated with manually indexing rich media and it enables the indexing of 100 percent of the speech information within audio files.

Another advantage and/or objective of the present invention is that it is speaker-independent, meaning it supports recognition for an unlimited number of speakers with different voices and accents. This is particularly useful with telephony and broadcast acoustic models where complex language analysis is necessary to produce superior results.

Still another advantage and/or objective of the present invention is that it provides higher accuracy levels. With studio-based content, where accuracy levels are relatively high, the present invention provides superior accuracy; however, it also provides superior accuracy for telephone, public presentation and broadcast content as well.

Yet another advantage and/or objective of the present invention is that it recognizes all words, not just keywords. The accuracy of preconfigured vocabularies can be further fine-tuned using the Vocabulary Tool to include organization-specific terms and proper names. This tool automatically customizes vocabularies with unique terms, such as industry-specific terminology or topics, resulting in outstanding recognition.

A further advantage and/or objective of the present invention is that it reduces the time required to view a video file and provides instant playback from a central repository.

A further advantage and/or objective of the present invention is that it supports video feeds from Police patrol cars which are involved, for example, in car chases which can then be used in court as supportive evidence.

Finally, the invention has been designed specifically for a web based application or site, and it allows for the translation of a document from one language to another. This is especially useful for making a worldwide distribution of the content, without the cost of paying for content translation and maintenance.

Other advantages and/or objectives will become apparent from the detailed description below when read in conjunction with the figures.

In accordance with one aspect of the invention, the aforementioned and other advantages are achieved by a method of processing an audio file. The method involves receiving an audio file and storing the audio file and demographic information pertaining to the audio file in a memory. The audio file may be converted into a standardized format if the audio file was not in the standardized format when received. A text file and a concordance file may be generated from the audio file. The concordance file may comprise a list of utterances from the audio file and, for each utterance, a plurality of words and a corresponding time stamp and confidence value for each of the plurality of words. An adjusted index file may be generated by parsing the concordance file and combining words, time stamps and confidence scores into corresponding text strings, time segments and confidence values as a function of predefined semantic rules, grammatical rules, punctuation rules and patterns of speech. The standardized audio file and text file may be synchronized using the adjusted index file.

In accordance with another aspect of the invention, the aforementioned and other advantages are achieved by a method of processing a multimedia file. The method involves receiving a multimedia file including a video file and an audio file and storing the multimedia file and demographic information pertaining to the multimedia file in a memory. The video file may be converted into a standardized video format if the video file is not in the standardized format when received. The audio file may likewise be converted into a standard audio format. A text file and a concordance file may be generated from the audio file. The concordance file comprises may comprise a list of utterances from the audio file and, for each utterance, a plurality of words and a corresponding time stamp and confidence value for each of the plurality of words. An adjusted index file may be generated by parsing the concordance file and combining words, time stamps and confidence scores into corresponding text strings, time segments and confidence values as a function of predefined semantic rules, grammatical rules, punctuation rules and patterns of speech. The audio file, video file and text file may be synchronized using the adjusted index file.

### BRIEF DESCRIPTION OF THE DRAWINGS

Several figures are provided herein to further the explanation of the present invention. More specifically:

FIG. 1 is a system diagram of the present invention in accordance with exemplary embodiments of the present invention;

FIG. 2 is a screen shot illustrating an one exemplary user interface for a user in accordance with exemplary embodiments of the present invention;

FIG. 3 is a screen shot illustrating another exemplary user interface for a user to upload a new audio or video file, in accordance with exemplary embodiments of the present invention;

FIG. 4 illustrates an exemplary IDX file;

FIG. 5 illustrates an exemplary AIX;

FIG. 6 illustrates an exemplary DFXP file;

FIG. 7 illustrates an exemplary user interface for a user to search stored audio and video files, in accordance with exemplary embodiments of the present invention;

FIG. 8 illustrates an exemplary user interface for a user to play back a video file, in accordance with exemplary embodiments of the present invention;

FIG. 9 illustrates an exemplary user interface for a user to display the entire text file while the video and/or audio is played back;

FIG. 10 illustrates an exemplary user interface for a user to select an alternative language from the pull down menu and translate the displayed text and closed captioning;

FIG. 11 illustrates an exemplary user interface for a user to view the translated text and closed captioning; and

FIG. 12 is a flow diagram that illustrates the general sequence associated with uploading, processing, playing back and editing audio and video files in accordance with exemplary embodiments of the present invention.

### DETAILED DESCRIPTION

It is to be understood that both the foregoing general description and the following detailed description are exemplary. As such, the descriptions herein are not intended to limit the scope of the present invention. Instead, the scope of the present invention is governed by the scope of the appended claims.

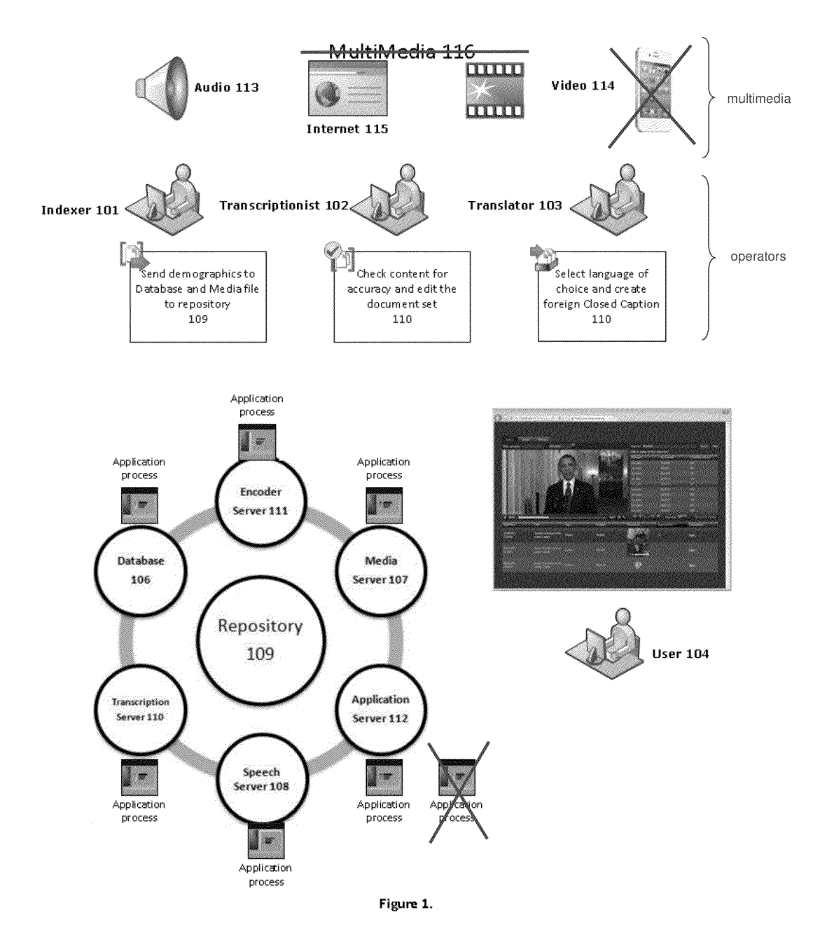

FIG. 1 is a system diagram in accordance with exemplary embodiments of the present invention. More particularly, FIG. 1 shows the placement and connectivity between the various operators and system components that process the sound and video (i.e., multimedia) files in accordance with the exemplary embodiments of the present invention. The system illustrated in FIG. 1 comprises, among other things, a repository 109, a media server 107, a speech server 108, a transcription server 110, an encoder server 111 and an application server 112. The system further comprises an Enterprise database 106, which may be implemented using a Microsoft SQL server.

The system illustrated in FIG. 1 provides users, such as user 104, with the ability to accurately search and playback files through their browser. When playing back a file, the audio, video (if present), text and close captioning (if present) are all accurately synchronized by virtue of the refined IDX file (i.e., the AIX file) described in detail below, which maintains accurate alignment of these files. This is true even when the text in the corresponding text file has been edited. Each of the system components will now be described in more detail herein below.

Repository 109 is in communication over a network connection with each of the other aforementioned system components, as illustrated. In general, the repository 109 stores the various audio, video, text and other files, described below. In addition, the software algorithms that control the various system functions are, in accordance with a preferred embodiment, stored in and executed from the application server 112. However, one skilled in the art will understand that the software algorithms could be stored elsewhere.

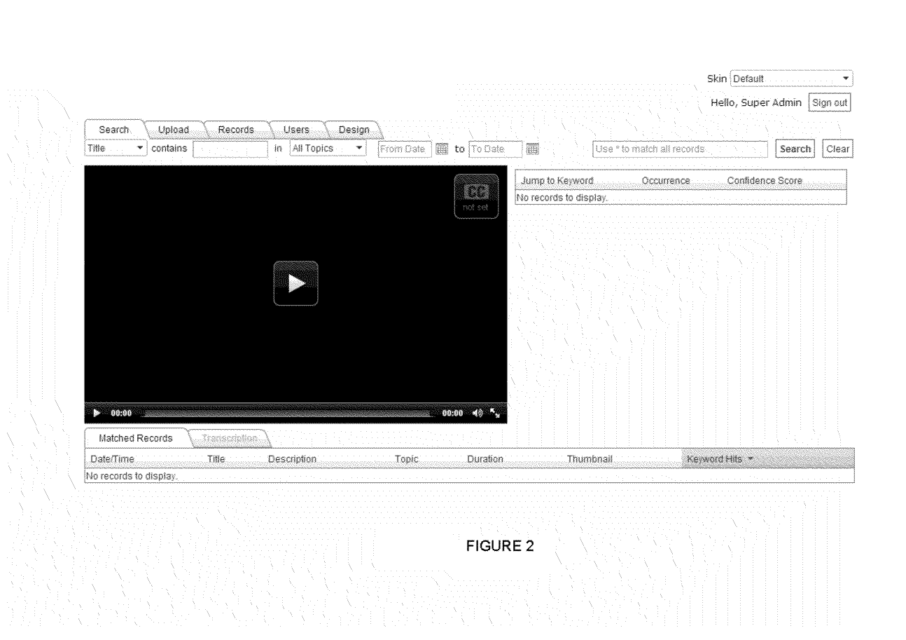

For ease of discussion, the aforementioned software algorithms will be collectively referred to herein as the system program. The system program allows a user to execute the various system functions. As the system program is stored in the application server 112, in accordance with the preferred embodiment, the user must first navigate to a corresponding IP address to start the system program. FIG. 2 is a screen shot illustrating an exemplary user interface that would be displayed and available to the user through a standard Internet browser upon navigating to the aforementioned IP address.

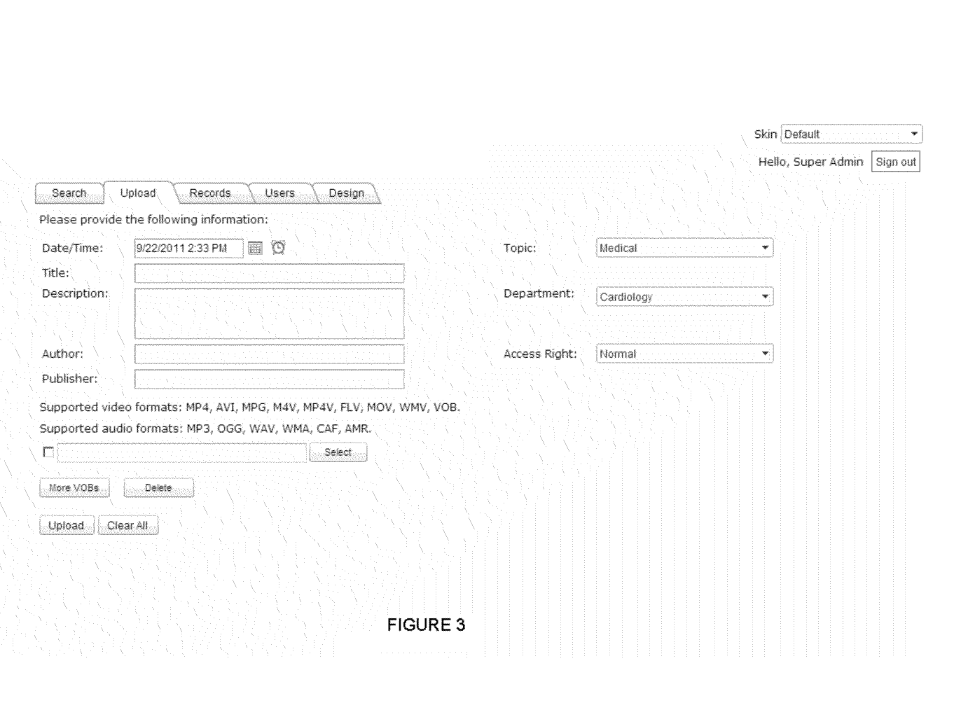

FIG. 3 is a screen shot illustrating an exemplary user interface that would be displayed and available to the user when the user is ready to upload a new audio or video file into the repository 109. It will be understood that the new audio or video file may be a digital recording previously stored in a memory that is accessible to the user, or the new audio or video file may be a live audio or video feed. Either way, the user will first provide certain demographic information for the new audio or video file using the data fields associated with the user interface illustrated in FIG. 3.

In FIG. 1, the user that uploads the new audio or video file and provides the demographic information is referred to as the indexer 101, and the data fields that the indexer 101 may fill in include a title; a description; the author; the publisher; a general topic area, e.g., medical, aircraft, sport and the like; the internal company or agency department; and access rights, where access rights relate to a level of classification which may be used later to restrict access to the stored audio or video files to only those individual users that have authorization. While the new audio or video file is stored in repository 109, the demographic information is, in accordance with the preferred embodiment, stored in database 106, where the demographic information is associated with the corresponding audio or video file stored in repository 109 by a unique name that may comprise all or a portion of the title provided by the indexer 101 and the time and date the indexer 101 stored the new file. Once the new audio or video file is stored in repository 109, the file may be referred to herein as a work in progress (WIP) file.

Turning our attention back to FIG. 1, encoder server 111 is, as stated, in communication with the repository 109 over a network connection. Encoder server 111 monitors the repository 109 for newly stored WIP files. If the encoder server 111 determines that a new WIP file has been uploaded into repository 109, the encoder server 111 will convert the file, if necessary, into a standardized audio and/or video format. In accordance with a preferred embodiment of the present invention, the standardized audio format is the MP3 and the standardized video format is the MP4 format. Therefore, if the WIP file is an audio file that is stored in the repository 109 in a format other than MP3, encoder server 111 will access the WIP file and convert the file to MP3 format. The MP3 file is then stored in the repository 109 using the aforementioned unique name with an MP3 extension (e.g., title_date-time.mp3). Audio formats other than MP3 include, but are not limited to OGG, WAV, WMA, CAF and AMR (see FIG. 3). If, on the other hand, the WIP file is a video file that is not already stored as an MP4 file, encoder 111 will convert the video track to MP4 and the audio track to MP3. It will then save the MP4 and MP3 in the repository 109 using the unique name with the appropriate extension (e.g., title_date-time.mp3 and title_date-time.mp4). However, if the WIP file is already stored as an MP4 file, encoder 111 will “rip” the audio component from the MP4 file and save it as an MP3 file in the repository 109 using the unique name and appropriate extension, as explained above. Video formats other than MP4 include, but are not limited to AVI, MPG, M4V, MP4V, FLV, MOV, WMV and VOB (see FIG. 3). Once the encoder server 111 stores the MP3 file and, if video is involved, the MP4 file in repository 109, the WIP file may be discarded.

The Speech server 108 then performs a speech recognition function. This may be accomplished, in whole or in part, using any one of several known speech recognition engines, such as Nuance's ASR (“Dragon”) engine. The speech server 108 performs its function in such a way that it is speaker independent so that the recognition levels are high. Additional vocabularies have been developed to compliment specific topics based on Law Enforcement, Homeland Security, Government and Legal spoken terms.

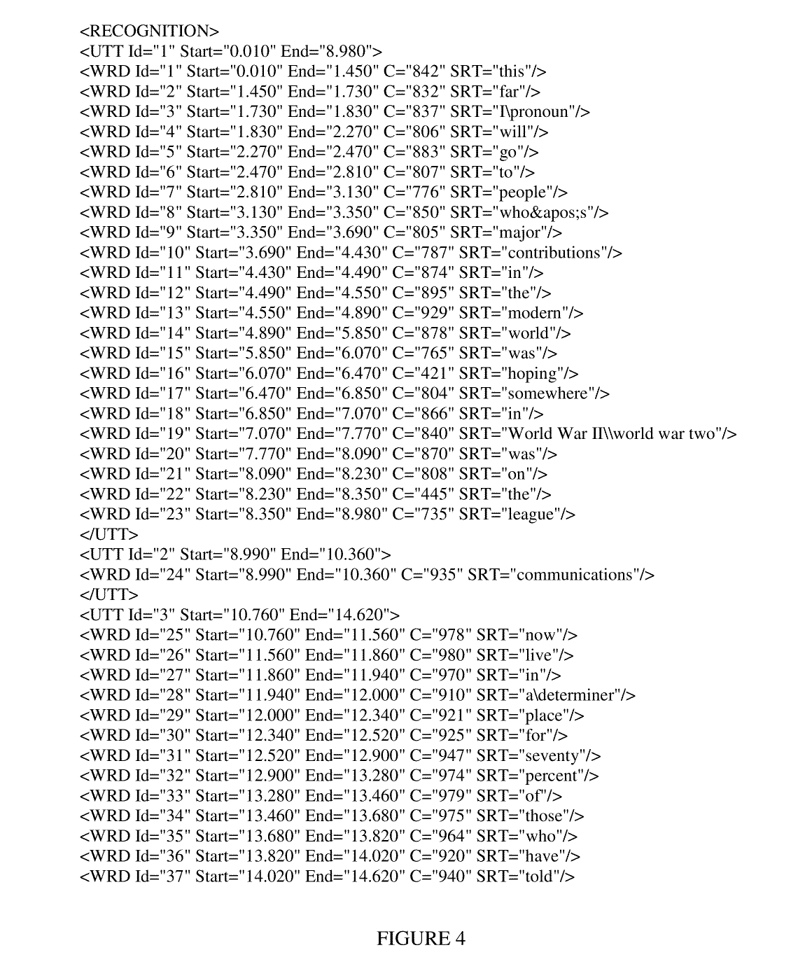

More specifically, speech server 108 operates on the MP3 file stored in repository 109 to generate two additional files, a text (ASCII) file and an index (IDX) or concordance file. The concordance file is typically in XML format and it comprises a list of every utterance in the MP3 file along with a corresponding time stamp, position and confidence level. FIG. 4 illustrates an exemplary IDX file. The text and IDX files are stored in repository 109 using the unique naming convention described above (e.g., title_date-time.txt and title_date-time.idx).

However, there is a deficiency with the IDX file function due to inaccuracies associated with speech recognition technologies, including the previously mentioned ASR engine. As a result, if it becomes necessary to edit the speech recognition processed text, the text in the text file with respect to the utterances in the corresponding IDX file, the audio in the corresponding MP3 file and the video in the corresponding MP4 file (assuming there is video) will no longer be synchronized. If the editing is extensive, the synchronization error will be extensive. Editing is typically accomplished by a user referred to as transcriptionist 102. As one skilled in the art will readily appreciate, this is likely to result in clipping when playing the speech recognition processed output file. This, in turn, may result in the loss of audio segments. The present invention rectifies these and other deficiencies, at least in part, with additional software residing in the application server 112.

The additional software residing in the application server 112 includes a text or IDX parser. The IDX parser, when executed, refines the IDX file. The refined IDX file is referred to herein as the refined concordance or AIX file. For reasons that will become more evident from the description below, the AIX file is a 100 percent accurate reflection of the text file, and this remains true even if the text file is later edited. As such, the synchronization issues mentioned above that plague the present technology do not exist with the present invention. In addition, the AIX file is also a more highly searchable file compared to the IDX file. The AIX file is stored in the repository 109 using the unique naming convention (e.g., title_date-time.aix)

The IDX parser generates the AIX file by extracting the transcribed words in the IDX file (see e.g., FIG. 4), together with the corresponding occurring time and confidence score. The IDX parser then combines all of the words, occurring time and confidence scores into respective text strings (with a space in between words). However, the IDX parser does more. When the IDX parser generates the respective text strings, it takes into consideration various semantics issues, grammatical rules, punctuation, pauses associated with the speech pattern and a set number of characters that should make up each line of text. For example, with regard to semantics, if the Nuance ASR engine outputs “two thousand and one,” the IDX parser will extract a new keyword “2001.”

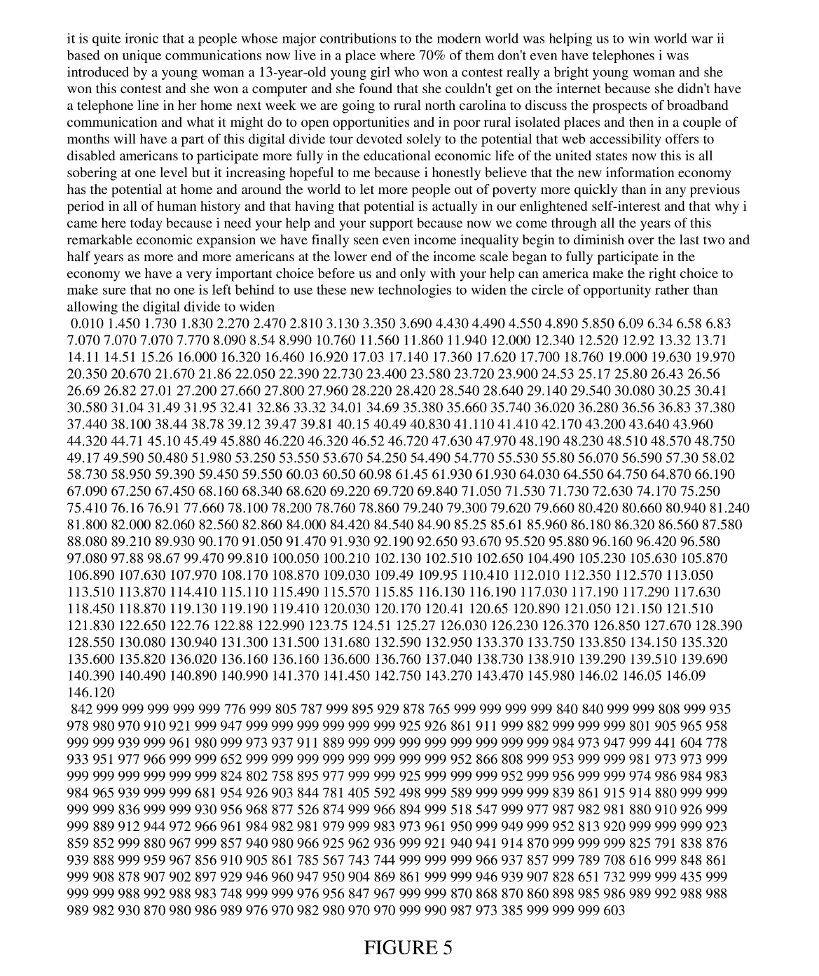

FIG. 5 illustrates an exemplary AIX file that is a refinement of the IDX file illustrated in FIG. 4. The text string format of the AIX file is faster to index and, more importantly, provides an easy way to search for multi-word keywords. In a preferred embodiment, all the words that appear in the AIX file are converted into lowercase before being saved in the text string to further improve the searching performance.

Because of its design and implementation logic, the IDX parser performs “under the bonnet” reorganization of the original IDX file format produced by the speech server 108. This ensures that all recognized text is properly structured and formatted, and that inconsistencies of normal speech engine output are removed. By simply adding an original dialogue media file input either from a video or dictation, the user can allow the system to manage the quality and high standards the invention produces.

The IDX parser uses several specially designed purpose built algorithms to manage and restructure the original defined IDX file. It analyzes the original output file and compares the semantics of word structures based on a defined logical scholastic binary tree. This means the user can benefit from a simple and semantic based output text file. A file can then be viewed and corrected to produce high quality output from the IDX enhancer. This ensures that all playback results are properly synchronized with the original video.

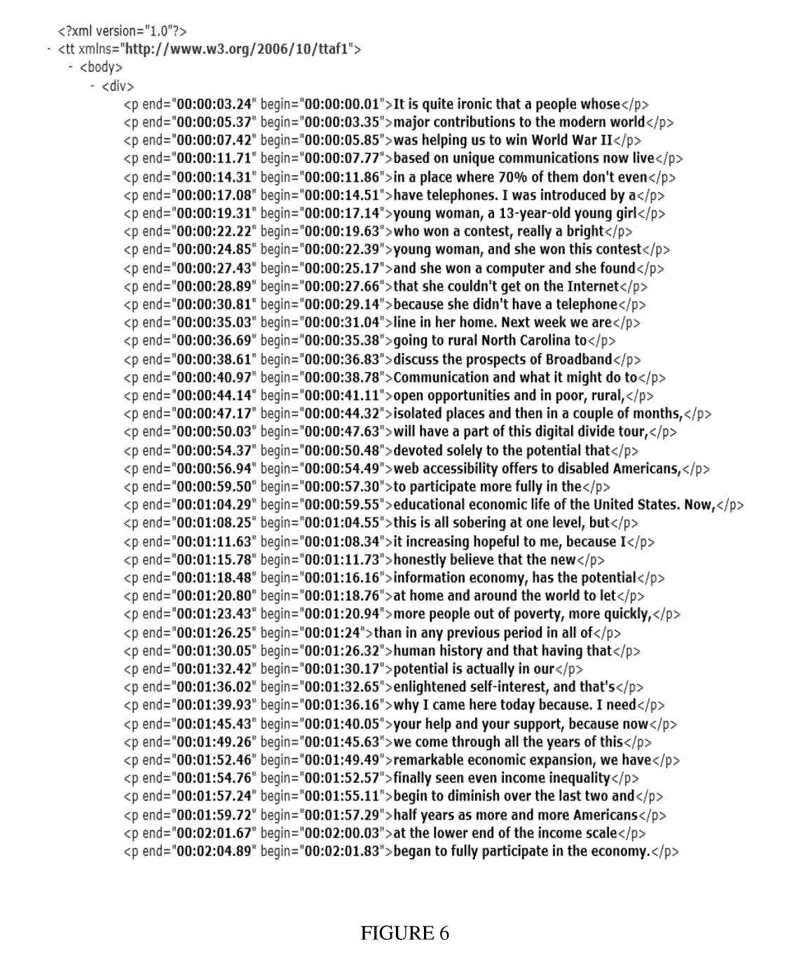

The IDX parser is also responsible for generating a DFXP file that may be used to support closed captioning when playing back a video file. The DFXP file refers to the widely-known Distribution Format Exchange Profile format. The IDX parser generates the DFXP file based on the structured timed data that resides in the AIX file. The process of generating the DFXP file from the AIX file is fully automated, and in generating the DFXP file, the same semantics issues, grammatical rules, punctuation, pausing and number of characters per line are taken into consideration. FIG. 6 illustrates an exemplary DFXP file that was generated based on the AIX file of FIG. 5. The DFXP file is stored in repository 109 using the same unique naming convention.

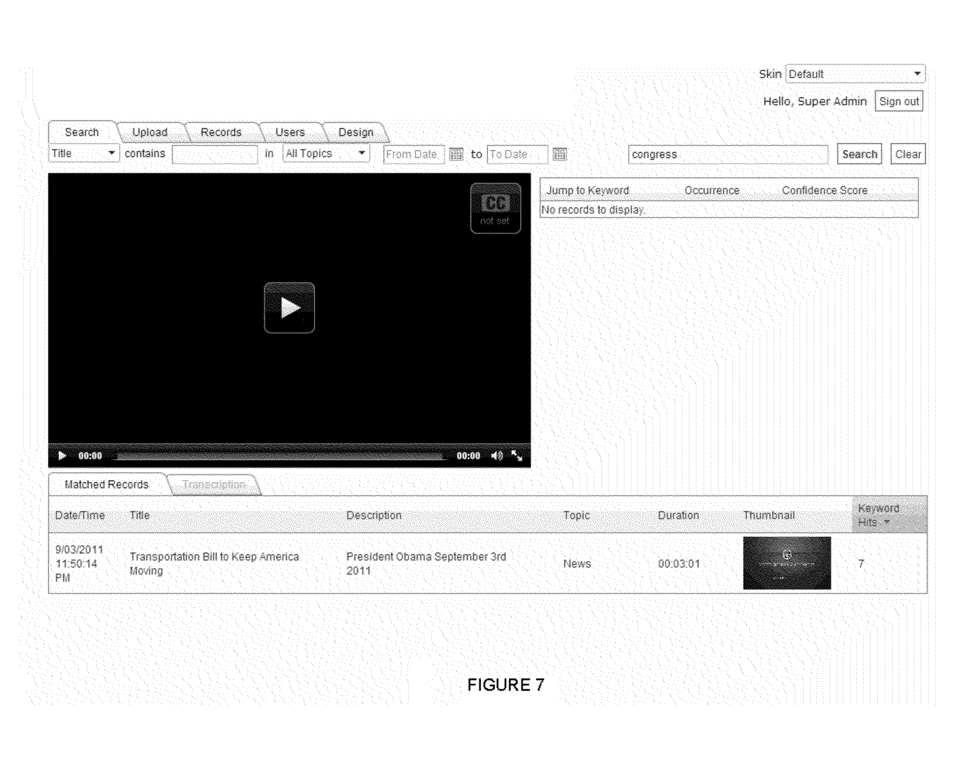

The repository 109 may, of course, store hundreds or thousands of speech processed audio and video files, where each is supported by corresponding MP3, MP4, text, AIX and DFXP files. As such, the stored audio and video files are highly searchable and accessible for playback. FIG. 7 illustrates an exemplary user interface provided by the system program that allows a user to search the audio and video stored in repository 109. In this example, the user searched all stored audio and video files where the corresponding text file contains at least one instance of the keyword “congress.” It will be understood that the user could have limited the search to less than all stored audio and video files using the aforementioned demographic information. In this example, the search returned only one stored video file titled, Transportation Bill to Keep America Moving.

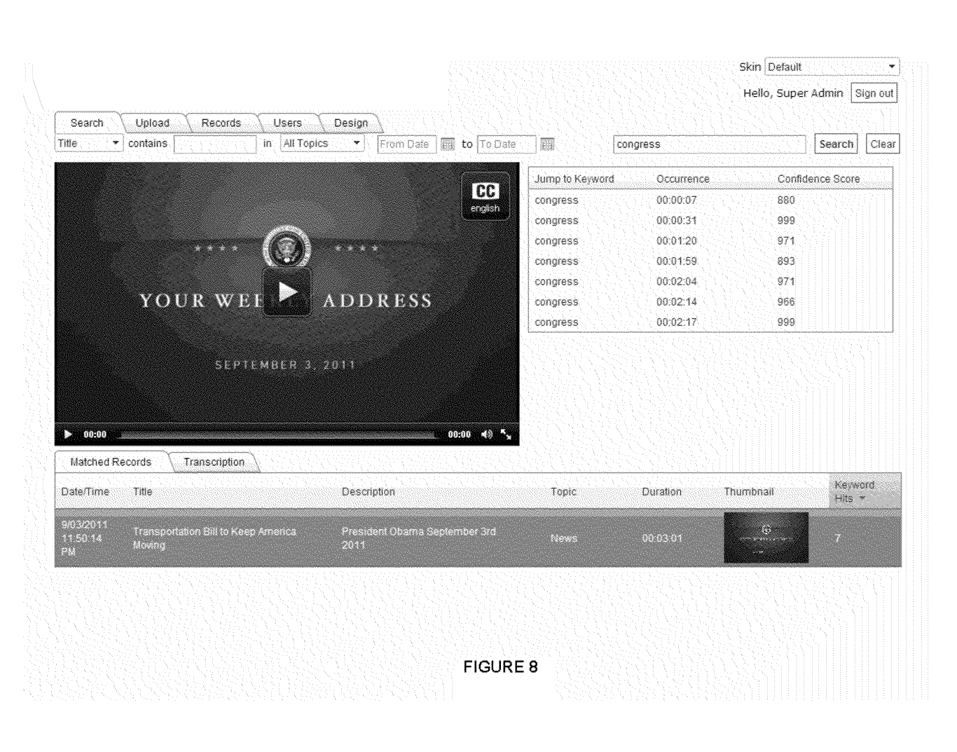

The user can then select the video for playback. If the user does select the video for playback, the system program may provide the exemplary user interface illustrated in FIG. 8. The user can then play back the entire video or the user can jump to and play back any one or more segments of the video where the corresponding audio segment contains the keyword “congress.” To jump to and play back a given video and audio segment containing the keyword “congress,” the user need only select the particular instance using the list provided on the right side of the user interface. This capability is made possible due to the fact that the AIX file is highly accurate and searchable

In playing back the audio and video content through the user's internet browser, any one of a number of known media streaming systems may be employed to stream the content to the user, for example, a Wowza® media system. In accordance with the preferred embodiment of the present invention, this functionality and capability resides in the media server 107, illustrated in FIG. 1.

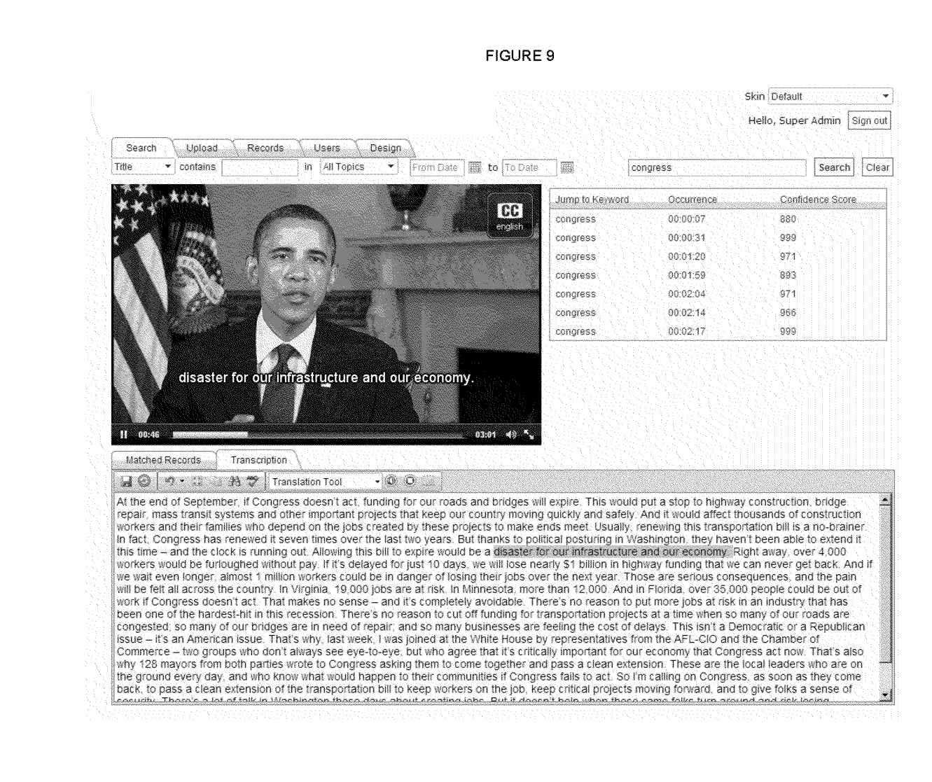

If the user is a transcriptionist, such as transcriptionist 102, the entire text file can be displayed while the audio is played back. This is illustrated in FIG. 9. In addition, the transcriptionist may have the desire to take advantage of closed captioning. As those skilled in the art understand, closed captioning is often a very useful tool for transcriptionists in, for example, the medical, legal and law enforcement fields. FIG. 9 also illustrates the use of closed captioning. It will be further understood that the system program renders the video by running the corresponding MP4 file, the audio by running the MP3 file and the closed captioning by running the DFXP file, all of which are stored in repository 109, as previously explained.

To further aid transcriptionist 102, the system program provides a highlighting capability. As illustrated in FIG. 9, the text string corresponding to the presently displayed closed caption text is highlight. As the video and audio progress and the close caption text changes, the highlight will accurately move with the changing closed captioned text. Again, this is made possible by the highly accurate AIX file and the DFXP file that is derived from the AIX file.

Of course, one of the main tasks of the transcriptionist is to verify the accuracy of the speech recognition processed text. In the event the transcriptionist 102 detects an error, the system program includes a text editing capability through transcription server 110 that allows the transcriptionist 102 to correct the text. In doing so, the transcriptionist is actually modifying the corresponding text (ASCII) file stored in repository 109.

The IDX parser plays a very important role in the text editing process. When the transcriptionist 102 makes a correction, for example, fixes the spelling of a word, the IDX parser performs two very important functions. First, it will automatically update the AIX file in accordance with the change that was made to the text file by transcriptionist 102. Second, it will automatically update the DFXP file based on the change that was made to the AIX file. Moreover, and most importantly, in updating the AIX file and then the DFXP file, it again does so taking into consideration the aforementioned semantics, grammar, punctuation and pauses in the speech pattern, while at the same time, maintaining the set number of characters per line. By doing this, the synchronization between the video, audio, text and closed captioning is strictly maintained, even after the transcriptionist has made significant changes to the text, thus avoiding the previously mentioned deficiencies associated with even the most technically advanced prior speech recognition systems.

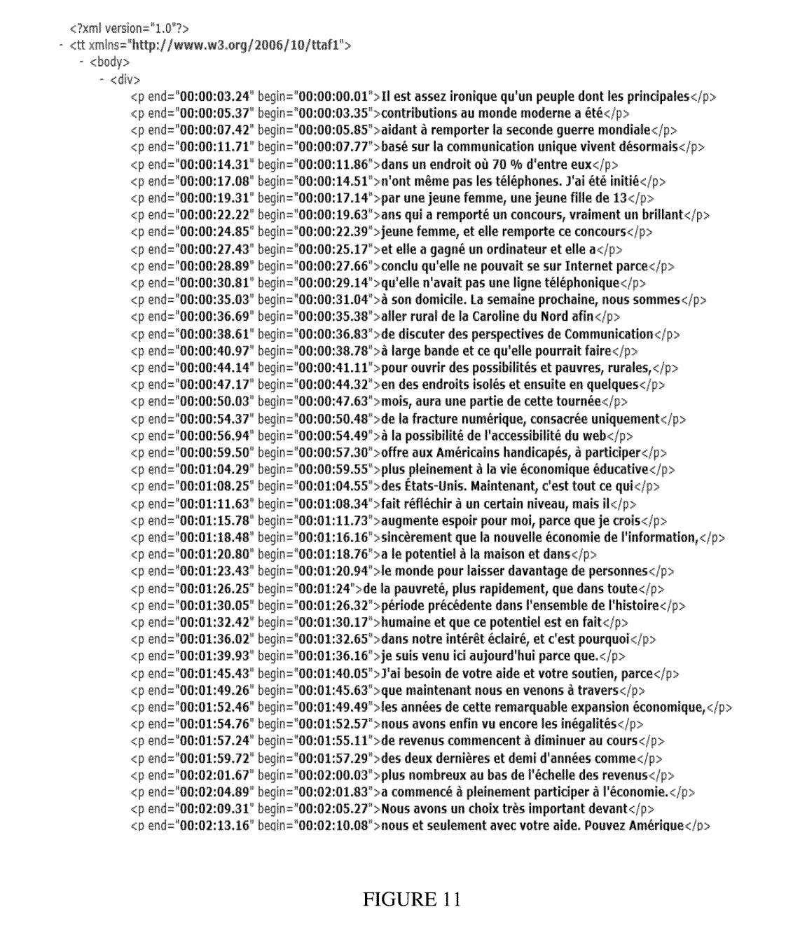

The user may not necessarily wish to render the text and closed captioning, if utilized, in English. Thus, the system program also provides the capability to instantaneously translate the text and closed captioning to any one of a number of alternative languages. FIG. 11 illustrates an exemplary user interface for this purpose.

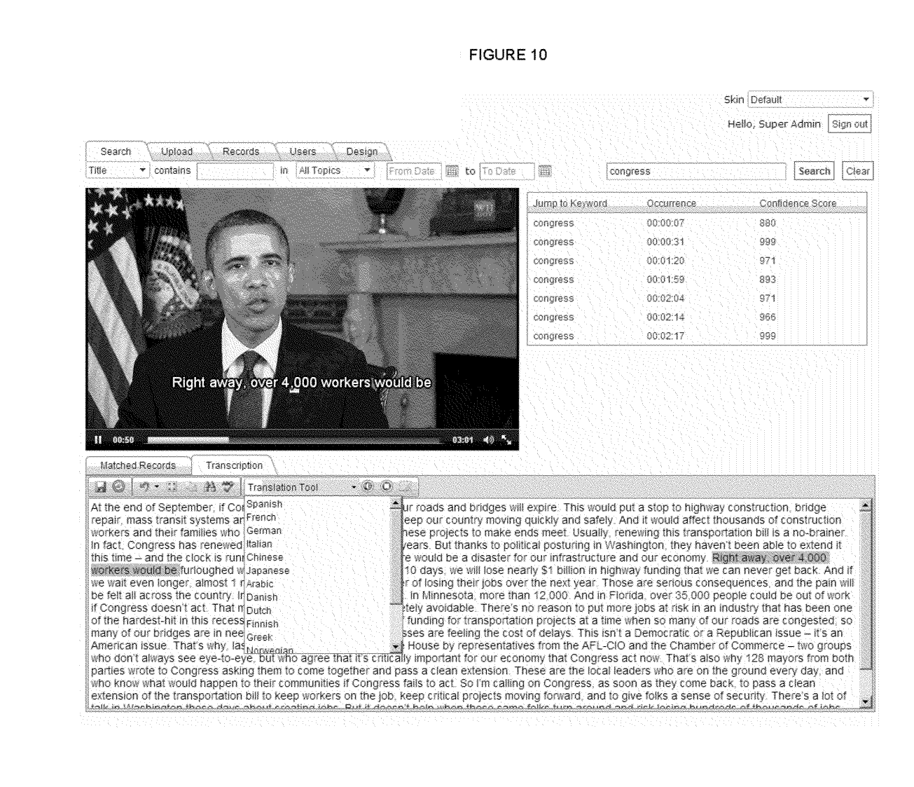

If, for example, the user identified as translationist 103 in FIG. 1 wishes to view the text and closed captioning in French, the translationist 103 would select French from the pull down menu illustrated in FIG. 10. After doing so, the system program will cause a new DFXP file to be generated in the French language. The French DFXP file will reflect the English DFXP. FIG. 11 illustrates an exemplary French DFXP file reflective of the corresponding English DFXP file of FIG. 6. Because the IDX file is able to maintain the synchronization between the audio, video, text, AIX and DFXP files, as explained above, and because the French DFXP file is a direct reflection of the English DFXP file, synchronization is accurately maintained during playback even if the text and closed captioning is displayed in another language other than English.

As one skilled in the art will readily appreciate from the description above, the present invention overcomes several deficiencies and disadvantages associated with prior systems. For example, certain prior systems, such as AURIX and NEXIDIA, employ phonetic search engines. Thus, they do not produce text files. Searching stored files relies on recognition of vague utterances rather than actual words. The process is cumbersome and anything but robust. The results are highly inaccurate and generally unacceptable where accuracy is strictly required. The present invention overcomes this deficiency, at least in part, by generating and updating the more accurate and highly searchable AIX file. The Nuance ASR engine, on the other hand, has different shortcomings, particular related to the inability to maintain synchronization between the audio, video, text and close captioning, as explained above, thus resulting in poor playback capability, especially after changes are made to the text. Here, the present invention overcomes these deficiencies, at least in part, by the use of the IDX parser which automatically generates, updates and maintains the AIX and DFXP files, taking into consideration such things as semantics, grammar, punctuation, pauses in the speech patter and a set number of characters for each text string

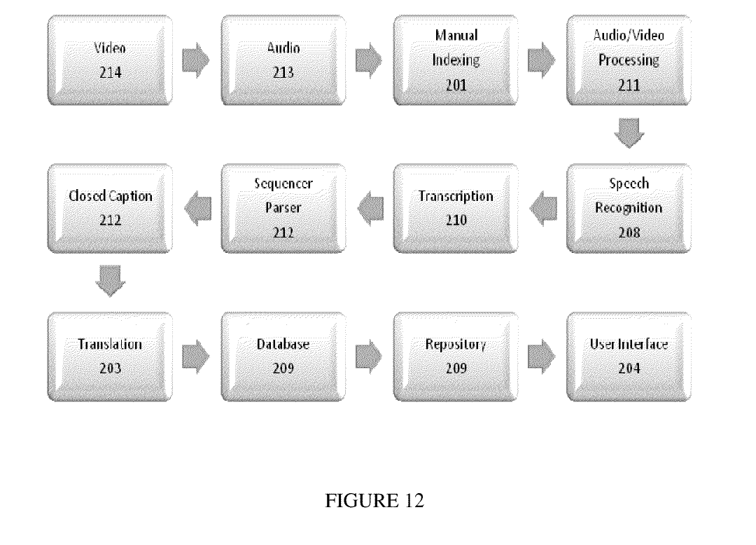

FIG. 12 is a flow diagram that illustrates the general sequence associated with uploading, processing, playing back and editing audio and video files in accordance with exemplary embodiments of the present invention. Thus, FIG. 12 shows the uploading of and exemplary video file 214 or audio file 213, followed by the manual indexing process 201, which involves the process of providing and storing, in the database 106, the demographic information associated with the video file 214 or the audio file 213. Next, the audio and/or video processing 211 takes place. This refers to the functions provided by encoder server 111, wherein the audio and/or video files 213 and 214 are converted, if necessary, to MP3 and MP4 format and stored in repository 109. The speech recognition process 208 then operates on the stored MP3 file. During the speech recognition process 208, a text (ASCII) file and concordance or IDX file are generated. An IDX parser then generates the AIX file from the IDX file and, in turn, the IDX parser generates a DFXP file (closed captioning file) from the AIX file. As explained above, the IDX parser generates these files in such a way that synchronization between the audio, video, text and closed captioning can be strictly maintain, even after the transcription process described below. All of the files are stored in repository 109, as explained above. The next process is the transcription process 210. Here, the audio or video files can be played back and, if necessary, a transcriptionist can edit the text file associated therewith. If the transcriptionist does make a change to the text file, the IDX parser automatically updates both the AIX file, as illustrated by process 212, and the DFXP file, also illustrated by process 212. If the transcriptionist or another user wishes to view the text and closed captioning in a language other than English, they can do so in accordance with process 203. As explained above, this involves the generation of another DFXP file in the desired non-English language, where the non-English DFXP file is derived from and completely and accurately reflects the English DFXP file. The demographic information, in accordance with the preferred embodiment of the present invention is stored and maintained in the database, as shown by process 209, whereas the audio and video files, including the MP3, MP4, text, IDX, AIX and DFXP files are stored in repository 109, also shown by process 209. Finally, the audio and video files can be searched, accessed, modified and translated as explained above through the user interface provided by the system program, as shown by process 204.

The present invention has been described above in terms of a preferred embodiment and one or more alternative embodiments. Moreover, various aspects of the present invention have been described. One of ordinary skill in the art should not interpret the various aspects or embodiments as limiting in any way, but as exemplary. Clearly, other embodiments are well within the scope of the present invention. The scope the present invention will instead be determined by the appended claims.

I claim:

1. A method of processing an audio file comprising:
receiving an audio file, storing the audio file and demographic information pertaining to the audio file in memory;
converting the audio file into a standardized format if the audio file was not in the standardized format when received;
generating a text file and a concordance file from the audio file, wherein the concordance file comprises a list of utterances from the audio file and, for each utterance, a plurality of words and a corresponding time stamp and confidence value for each of the plurality of words;
generating an adjusted index file by parsing the concordance file and combining words, time stamps and confidence scores into corresponding text strings, time segments and confidence values as a function of predefined semantic rules, grammatical rules, punctuation rules and patterns of speech; and
synchronizing the standardized audio file and text file using the adjusted index file.

2. The method of claim 1, wherein the standardized format for the audio file is MP3 format.

3. The method of claim 1, wherein the text file is in ASCII format.

4. The method of claim 1, wherein the concordance file is in XML format.

5. The method of claim 1 further comprising:
receiving edits to the text file; and
automatically updating the text strings and time segments in the adjusted index file as a function of the edited text file.

6. The method of claim 1 further comprising:
searching the adjusted index file for the presence of a keyword; and
displaying the text associated with the adjusted index file and the occurrence time and the confidence value corresponding to each instance of the keyword in the adjusted index file.

7. The method of claim 6 further comprising:
storing a video file in a standard format, wherein the video file corresponds to the audio file;
generating a closed caption file, containing closed caption text, from the adjusted index file; and
displaying the video associated with the video file, the text and the closed caption text associated with the adjusted index file and playing back the audio associated with the audio file, wherein the video, audio, text and closed caption text are synchronized as a function of the adjusted index file.

8. The method of claim 7 further comprising:
translating the text strings of the adjusted index file into another language;
generating a closed caption file, containing translated closed caption text, from the translated text strings of the adjusted index file;
displaying the video associated with the video file, the translated text and the translated closed caption text associated with the adjusted index file and playing back the audio associated with the audio file, wherein the video, audio, translated text and translated closed caption text are synchronized as a function of the adjusted index file.

9. A method of processing a multimedia file comprising:
receiving a multimedia file including a video file and an audio file, storing the multimedia file and demographic information, pertaining to the multimedia file, in memory;
converting the video file into a standardized video format if the video file is not in the standardized format when received;
converting the audio file into a standardized audio format if the audio file was not in the standardized format when received;
generating a text file and a concordance file from the audio file, wherein the concordance file comprises a list of utterances from the audio file and, for each utterance, a plurality of words and a corresponding time stamp and confidence value for each of the plurality of words;
generating an adjusted index file by parsing the concordance file and combining words, time stamps and confidence scores into corresponding text strings, time segments and confidence values as a function of predefined semantic rules, grammatical rules, punctuation rules and patterns of speech; and
synchronizing the standardized audio file, standardized video file and text file using the adjusted index file.

10. The method of claim 9, wherein the standardized format for the audio file is MP3 format.

11. The method of claim 9, wherein the standardized format for the video file is MP4.

12. The method of claim 11 further comprising:
ripping the audio file from the video file if the video file was received in the MP4 format; and
converting the audio file to MP3 format.

13. The method of claim 9, wherein the text file is in ASCII format.

14. The method of claim 9, wherein the concordance file is in XML format.

15. The method of claim 9 further comprising:
receiving edits to the text file; and
automatically updating the text strings, time segments and confidence values in the adjusted index file as a function of the edited text file.

16. The method of claim 9 further comprising:
searching the adjusted index file for the presence of a keyword; and
displaying the text associated with the adjusted index file and the occurrence time and the confidence value corresponding to each instance of the keyword in the adjusted index file.

17. The method of claim 16 further comprising:
generating a closed caption file, containing closed caption text, from the adjusted index file; and
displaying the video associated with the video file, the text and the closed caption text associated with the adjusted index file and playing back the audio associated with the audio file, wherein the video, audio, text and closed caption text are synchronized as a function of the adjusted index file.

18. The method of claim 17 further comprising:
translating the text strings of the adjusted index file into another language;
generating a closed caption file, containing translated closed caption text, from the translated text strings of the adjusted index file;
displaying the video associated with the video file, the translated text and the translated closed caption text associated with the adjusted index file and playing back the audio associated with the audio file, wherein the video, audio, translated text and translated closed caption text are synchronized as a function of the adjusted index file.

19. A method of processing a file having audio data stored therein, the method comprising:
receiving the audio data, storing the audio data and demographic information pertaining to the audio data in a memory;
converting the audio data from a first format to a second format, different from the first format, if the audio data was not in the second format when received;
generating a text file and a concordance file from the audio data, wherein the concordance file comprises a list of utterances from the audio data and, for each utterance, a plurality of words and a corresponding time stamp and confidence value for each of the plurality of words;
generating an adjusted index file by parsing the concordance file and combining words, time stamps and confidence scores into corresponding text strings, time segments and confidence values as a function of predefined semantic rules, grammatical rules, punctuation rules and patterns of speech; and
synchronizing the audio data in the second format and the text file using the adjusted index file.

20. The method of claim 19, wherein the second format is a predefined audio format.

21. The method of claim 20, wherein the predefined audio format is in accordance with an MP3 standard.

22. The method of claim 19, wherein the file further has video data stored therein, the method further comprising:
converting the video data from a first video format to a second video format if the video data is not in the second video format when received; and
synchronizing the video file in the second video format, with the audio data in the second format and the text file using the adjusted index file.
